(19) United States
(12) Patent Application Publication
(10) Pub. No.: US 2019/0097545 A1
(43) Pub. Date: Mar. 28, 2019

(54) MIXED-SIGNAL FULL-WAVE PRECISION RECTIFIER

(71) Applicant: Microsoft Technology Licensing, LLC, Redmond, WA (US)

(72) Inventor: Gabriel A. COHN, Sammamish, WA (US)

(73) Assignee: Microsoft Technology Licensing, LLC, Redmond, WA (US)

(21) Appl. No.: 15/716,416

(22) Filed: Sep. 26, 2017

(51) Int. Cl. H02M 7/217; H02M 1/08

(52) U.S. Cl. CPC H02M 7/217; H02M 2001/0003; H02M 1/08

(57) ABSTRACT

Apparatus and methods are described for providing a mixed-signal full-wave precision rectifier. In one example of the disclosed technology, a full-wave rectifier circuit includes a comparator configured to output a logic 1 or logic 0 by comparing an analog input signal to a reference voltage. The circuit further includes an analog switch with a control input coupled to the comparator output. A first input of the analog switch is coupled to the analog electrical input and a second input of the analog switch is coupled to a reference input voltage. The switch thus selects the input signal or the reference signal to output based on the output of the comparator. An amplifier is coupled to receive the analog switch output and generate a signal following the input in an inverting or a non-inverting mode depending on the selected analog switch output, thereby generating a rectified full-wave output of the analog input signal.

### BACKGROUND

Precision full-wave rectifiers can be used in electronic circuitry to generate the absolute value of a signal. This functionality may be used for magnitude detection in average value measurement applications and in amplitude modulation radio receivers. Full-wave precision topologies are currently constructed using active components such as operational amplifiers configured with a diode in a feedback loop. These topologies typically are deployed for use at audio frequencies and lower, and generally exhibit relatively high power consumption. Thus, there is ample opportunity for improvement of full-wave rectifiers.

### SUMMARY

Mixed-signal full-wave precision rectifiers are disclosed that can be used to generate an absolute value of an input signal. Such rectifiers can be used to take the absolute value of an input signal, thereby converting the input signal from bipolar to unipolar form and have a number of useful applications, including magnitude detection, which can be used with sensors, including bioimpedance sensors, and in other applications. Circuits manufactured according to certain example topologies disclosed herein use a mix of analog and mixed-signal components to allow operation at substantially high frequencies. Such circuits can be configured to operate using relatively lower power and fewer components than other approaches using only analog components.

In some examples of the disclosed technology, an apparatus includes a comparison circuit configured to generate an output signal indicating whether an input signal voltage is greater than a reference signal voltage. An analog selector is configured to, based on the comparison output signal, select and output one of a plurality of two or more input signals, (which plurality includes the input signal) as an analog selector output signal. An amplifier receives the analog selector output signal and generates an output signal that substantially follows the input signal. The mode with which the amplifier follows the received signal is selected based in part on the analog selector output signal. For example, the amplifier can be configured to operate in an inverting amplifier mode or in a non-inverting amplifier mode based on the analog selector output signal. In some examples, the analog selector can include an analog multiplexer, an analog switch, a transmission gate, or a pass gate. In some examples, the circuit can be operated using a single power supply voltage, while other examples use a plurality of several power supply voltages. In some examples, additional components are used in order to allow for operation of the circuit at high frequencies. For example, the output amplifier can be configured using a feedback capacitor or other compensation circuity to maintain stability of the amplifier at high frequency operation. In some examples of the disclosed technology, the comparison circuit provides an amount of hysteresis selected to avoid multiple switching transitions from noise as the input signal approaches a reference voltage. In some examples, low pass filters (e.g., resistor-capacitor (RC) filters) are provided to reduce or eliminate high-speed switching transients from the output of the circuit. In some examples, the analog selector does not include any diode components.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. The foregoing and other objects, features, and advantages of the invention will become more apparent from the following detailed description, which proceeds with reference to the accompanying figures.

### BRIEF DESCRIPTION OF THE DRAWINGS

FIG. 1 is a diagram illustrating a comparison circuit, analog selector, and amplifier, as can be implemented in certain examples of the disclosed technology.

FIG. 2 is a schematic illustrating a circuit including a comparator, an analog switch, and an output amplifier, as can be implemented in certain examples of the disclosed technology.

FIG. 3 is a schematic illustrating a more specific example of a configuration of a comparator, an analog switch, and an amplifier, as can be implemented in certain examples of the disclosed technology.

FIG. 4 is a schematic diagram of an analog multiplexer, as can be implemented in certain examples of the disclosed technology.

FIG. 5 depicts displays generated by an oscilloscope measuring wave forms generated using the circuit depicted in FIG. 3.

FIG. 6 is a schematic illustrating a circuit including a comparator, an analog switch, and two amplifiers in an alternative configuration of the disclosed technology.

FIG. 7 is a flowchart outlining an example method of generating an output signal following an input signal using disclosed comparison circuits and analog switches.

FIG. 8 is a flowchart outlining an example method of generating an output signal following an input signal using disclosed comparison circuits and analog switches.

### DETAILED DESCRIPTION

### I. General Considerations

This disclosure is set forth in the context of representative embodiments that are not intended to be limiting in any way.

As used in this application the singular forms “a,” “an,” and “the” include the plural forms unless the context clearly dictates otherwise. Additionally, the term “includes” means “comprises.” Further, the term “coupled” encompasses electrical and magnetic ways of coupling or linking items together, and does not exclude the presence of intermediate elements between the coupled items. Furthermore, as used herein, the term “and/or” means any one item or combination of items in the phrase.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed things and methods can be used in conjunction with other things and methods. Additionally, the description sometimes uses terms like “produce,” “generate,” “display,” “receive,” “follow,” “select,” and “output” to describe the disclosed methods. These terms are high-level descriptions of the actual operations that are performed. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

### II. Example Full-Wave Rectifier Apparatus

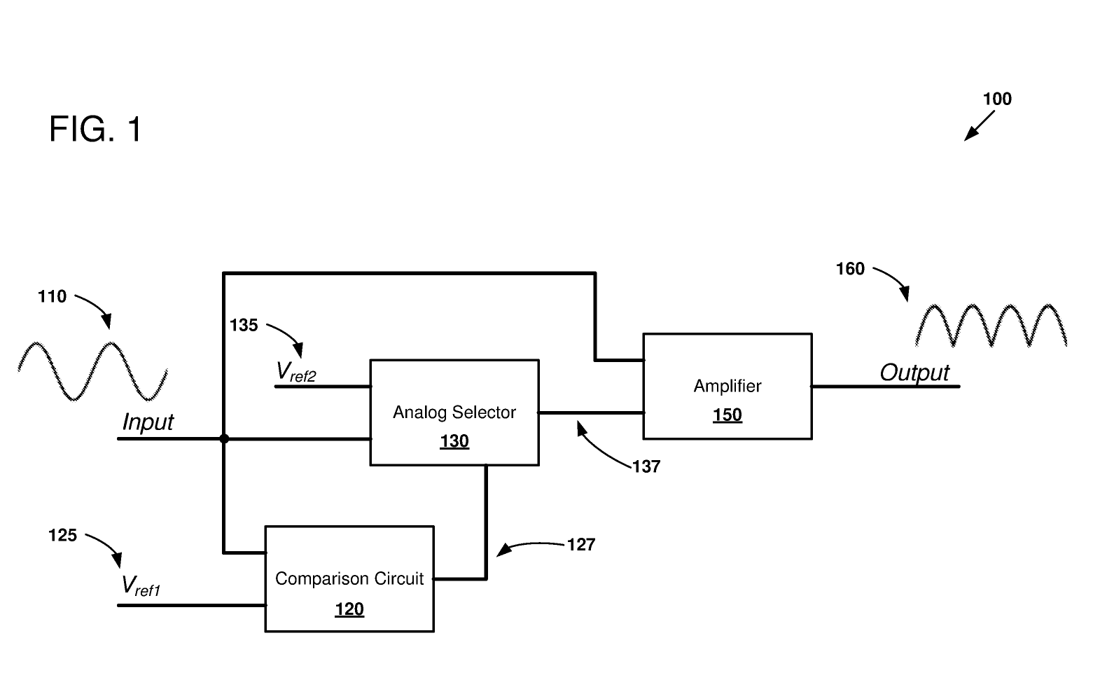

FIG. 1 is a block diagram of an apparatus that can be used as a full-wave rectifier in some examples of the disclosed technology. The components in the diagram 100 can be integrated onto a single integrated circuit substrate or can be provided by connecting discrete components that are assembled on, for example, a printed circuit board assembly.

The illustrated apparatus receives an input signal 110 via an electrical connection, for example, a printed circuit wire trace or a wire fabricated on an integrated circuit substrate. The input signal 110 is provided to a comparison circuit 120. The comparison circuit also receives a reference signal 125 denoted V_{ref1}. The comparison circuit includes circuitry to compare the voltages of the input signal and the reference signal and to output a comparison output signal 127 that indicates whether the input signal voltage is greater than the reference signal voltage. For example, when the input signal voltage is negative relative to the reference signal 125, the comparison circuit 120 outputs a first voltage, and when the input signal voltage is greater than the reference voltage, the comparison circuit outputs a second voltage level. The first voltage level can be, for example, a digital signal at the power supply voltage (e.g., 5.0 volts (V)) and the logic 0 value can be another power supply voltage, for example, a ground voltage (e.g., 0.0 V). The comparison circuit 120 can include at least one of the following types of circuits in order to compare its two input signals: a comparator with a digital output, an operational amplifier, a difference amplifier, an absolute value circuit (for example, an inverting amplifier implemented with an operational amplifier having a diode in its feedback path), or a Schmitt trigger. In some examples, the output of the comparison circuit 120 can be differential and thus the output value is represented as the difference between two or more output voltages. In some examples, the comparison circuit 120 generates its comparison output signal 127 as a digital output level at about either a first power supply voltage or at about a second power supply voltage and the reference signal is a steady state voltage selected to be somewhere between the first power supply voltage and the second power supply voltage. For example, the reference signal can be at 2.5 volts, the first power supply voltage is at 5.0 volts, and the second power supply voltage is at 0 volts. In some examples, the reference signal is tied to a ground voltage.

In some examples, the amplitude of the input signal 110 provided can be substantially in a range between a ground voltage and a power voltage. In other examples, the amplitude of the input signal 110 provided can contain both positive and negative voltages compared to a ground voltage. In some examples, the comparison circuit only has power supply inputs that are ground voltage and power voltage. In other examples, the comparison circuit can have other power voltage inputs including, for example, negative voltage inputs and/or voltages that are substantially above and below the voltages used by digital circuits integrated with the comparison circuit 120. In some examples, the comparison circuit 120 may have separate power supply inputs for the input stage and the output stage.

The comparison output signal 127 generated by the comparison circuit 120 is provided to an analog selector 130 which has a first input that is electrically coupled to receive the input signal 110 and a second input electrically coupled to a reference signal 135, which is annotated in the figure as V_{ref2}. In some examples, the first reference signal 125 and the second reference signal 135 are electrically connected to the same signal. In other examples, the two reference signals can be connected to different signals or different voltages. The analog selector 130 is configured to, based on the comparison output signal 127 received from the comparison circuit 120, select an output from one of a plurality of input signals and produce an analog selector output signal 137. The plurality of input signals includes at least the input signal 110 and the second reference signal 135. In some examples, the analog selector 130 is configured to select only between the input signal and the second reference signal. In other examples, the analog selector is configured to select from three, four, or more input signals. The analog selector 130 can be configured according to a variety of circuit arrangements. In many examples, it is typically desirable that the analog selector 130 be able to quickly switch between the input signal 110 and the reference signal 135. For example, when the comparison output signal 127 is a logic 1 value, the analog selector 130 selects the second reference voltage 135 to output as an analog selector output signal. When the comparison output signal 127 received at the analog selector 130 is logic 0, then the analog selector is configured to select the input signal 110 as the analog selector output signal 137.

The analog selector 130 can be implemented with a number of different types of circuitry, including an analog multiplexer, an analog switch, or as a number of transmission gates or pass gates. In many examples, it is desirable that the analog selector 130 be able to switch relatively quickly (e.g., on the order of a few nanoseconds). When the analog selector can switch at such high frequencies, very rapid input signals (e.g., greater than 100 kHz, or even greater than 500 kHz) can be rectified using the illustrated apparatus. In some examples, the analog selector 130 does not include any diode components.

As shown in the block diagram 100, the circuit further comprises an amplifier 150 that generates an output signal following the analog selector output signal received from the analog selector 130. As used herein, the terms “following” and “follows” refer to the output of an amplifier generating a non-inverted or an inverted waveform having an amplitude that is substantially a linear function of the input. Thus, an output signal having amplitude that is substantially the absolute value of the input is an output signal that “follows” the input signal. In some examples, an output signal can follow the input signal, but have a higher or lower absolute amplitude due to the gain or attenuation of the generating amplifier. As used herein, “amplify” and “amplifier” include not only operations and components that follow a signal with a gain greater than 1.0 or gain of less than 1.0, but also include such operations and components having a gain of less than or equal to 1.0 or greater than or equal to 1.0.

When the comparison circuit 120 selects the input signal as the analog selector output signal, the output of the amplifier 150 will follow the input signal 110, acting as a non-inverting amplifier (i.e., the effective amplifier gain is greater than 0). When the analog selector selects the second reference voltage 135 based on the comparison output signal 127, the analog selector 130 will output the second reference signal. In this case, the amplifier 150 follows the input signal 110, and operates like an inverting amplifier by producing an inverse of the input signal (i.e., the effective amplifier gain is less than 0). Thus, as shown, the analog selector 130 will switch each time the input signal 110 crosses the voltage level of the first reference signal 125, resulting in an output signal 160 that is a full-wave rectified version of the input signal 110, for example a sine wave as depicted in FIG. 1.

In some examples of the disclosed technology, the operation of the illustrated apparatus can be adapted to perform different functionalities. For example, the apparatus can be configured so that the input signal is followed when its voltage is below the first reference signal 125 voltage, producing an inverted rectified signal (e.g., a signal that is substantially the negative absolute value of the input signal 110). The apparatus can be so configured by swapping the inputs of a comparator used in the comparison circuit 120, swapping the inputs to the analog selector 130, or inverting the comparison output signal 127 provided to the analog selector. In some examples, producing an inverted rectified signal is desirable when a following stage that receives the output is an inverting stage.

### III. Example Mixed-Signal Topology for Full-Wave Rectification

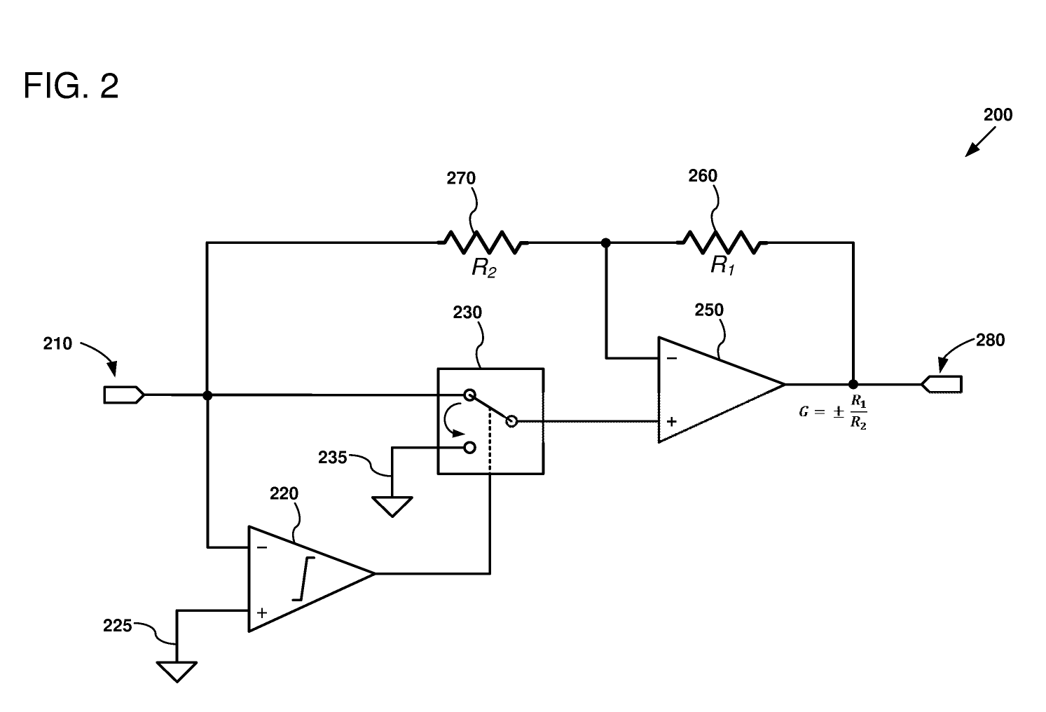

FIG. 2 is a schematic 200 illustrating a mixed-signal topology that can be used for full-wave rectification in certain examples of the disclosed technology. As shown, the circuit of FIG. 2 includes an input that receives an input signal 210 which is provided to the inverting input of a comparator 220. The non-inverting input of the comparator 220 is connected to ground 225. When the input signal 210 is at a positive voltage relative to ground, the comparator 220 outputs a logic 0. When the input signal 210 is negative, the comparator 220 outputs a logic 1. The output levels of the comparator 220 can be generated as full-rail output voltages. For example, when the power supplied to the comparator is VCC and ground, the output of the comparator will quickly rise or fall to the corresponding voltage (e.g., logic 1, VCC, and logic 0, ground) depending on the voltage of the input signal 210.

The illustrated schematic further includes an analog switch 230 having a control input coupled to the comparator output. When the comparator outputs a logic 0, this causes the analog switch 230 to output the input signal 210. Thus, the output of the analog switch 230 will substantially follow the input signal 210. Similarly, when the comparator outputs a logic 1, the analog switch will connect to the illustrated ground connection 235 and thus, the switch output will be the ground voltage. The selected output of the analog switch is electrically coupled to a non-inverting input of an amplifier 250. When the analog switch output is selected to output the input signal 210, the amplifier 250 will operate to follow the input signal 210 in a non-inverting manner. When the analog switch outputs a ground signal, then the amplifier 250 operates as an inverting amplifier, following the input with a negative gain.

The output of the amplifier 250 is coupled to a first resistor 260 having a resistance of R₁, which is fed back and coupled to the inverting input of the amplifier 250. A second resistor 270 is coupled to the inverting input of the amplifier 250 and the other terminal is coupled to the input signal 210. The second resistor 270 has a resistance value of R₂. The resistance values R₁ and R₂ can be selected based on desired circuit performance. For example, to output a rectified output signal 280 having substantially the same amplitude as the input signal 210, the resistance values of R₁ and R₂ should be selected to be equal. Thus, when the input signal is provided to the non-inverting input of the amplifier by the analog switch 230, the amplifier acts as a follower having a gain of 1. When the analog switch 230 selects the ground output which arrives at the non-inverting input, then the amplifier 250 will operate as an inverting amplifier having a gain of 1 times R₁ divided by R₂, which will be −1 when R₁ and R₂ are equal.

As the comparator 220 and the analog switch 230 can be selected from components that are designed to toggle their outputs relatively quickly, for example, within a few nanoseconds, relatively high switching frequencies can be achieved. Further, the comparator and analog switch can be designed for substantially digital operation, and thus, can be optimized to toggle relatively quickly and avoid remaining in the power-intensive linear operation region, as would occur with operational amplifier implementations. Further, the analog switch 230 can be implemented with relatively low power consumption using digital switching transistors, for example, field effect transistors (FETs), bipolar junction transistors (BJTs), carbon nanotubes, silicon nanowires, or a microelectromechanical system (MEMS) switch.

In some examples of the disclosed technology, the operation of the illustrated mixed-signal topology can be adapted to perform different functionalities. For example, the topology can be configured so that the input signal 210 is followed when its voltage is below the ground 225 voltage, producing an inverted rectified signal (e.g., a signal that is substantially the negative absolute value of the input signal 210). The apparatus can be so configured by swapping the inputs of the comparator 220, swapping the inputs to the analog switch 230, or inverting the comparison output signal provided to the analog selector. In some examples, producing an inverted rectified signal is desirable when a following stage that receives the output is an inverting stage.

### IV. Example Circuit Providing Full-Wave Rectification

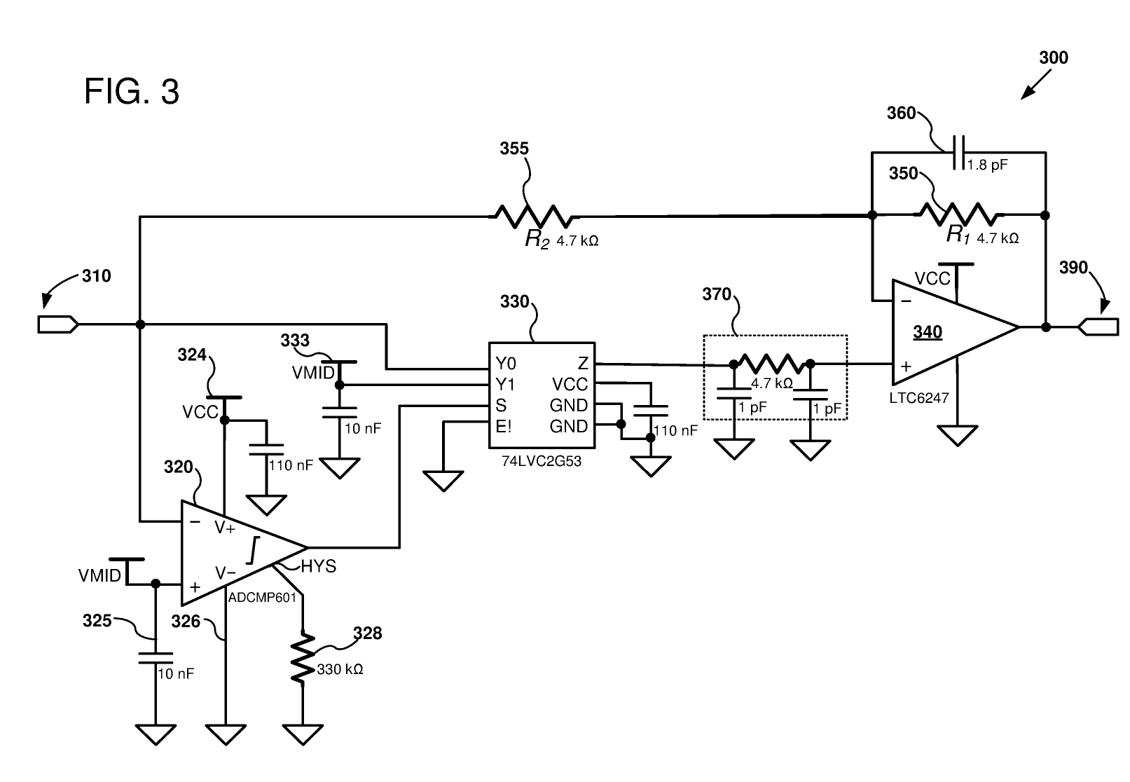

FIG. 3 is a schematic 300 depicting a circuit that can be used to provide full-wave rectification, as can be implemented in certain examples of the disclosed technology. In some examples, the schematic can be implemented, at least partially, by combining components on a single integrated circuit substrate. In other examples, the circuit can be provided by electrically coupling discrete components, including discrete active components that are electrically coupled via a printed circuit board or flexible circuit board.

As shown in FIG. 3, an input signal 310 is received by a comparator 320 at its inverting input. The comparator 320 further has a non-inverting input coupled to a reference voltage VMID. A capacitor 325 is inserted between the VMID node and the ground node to reduce high frequency noise on VMID. The comparator 320 has two power supply inputs: V+ which receives power supply VCC 324 and which can be selected at a suitable digital voltage level, for example 5.0 volts, and a negative power supply input V−, which is coupled to ground 326 (0.0 volts). The comparator 320 is further coupled to a resistor 328 that couples the hysteresis input of the comparator to ground through the resistor. The output of the comparator 320 is electrically coupled to a control input S of an analog switch 330. The depicted analog switch 330 has two inputs: Y0, which is connected to the input signal 310, and Y1, which is coupled to the reference voltage VMID. In the illustrated example, a single power supply implementation is used, and the reference voltage VMID 333, which can also be dubbed a virtual ground, is selected between the two power rails (for example, at 2.5 volts). Other inputs of the analog switch 330 include its power supply, which is coupled to VCC and ground respectively, and an enable signal E!, which is an active low signal that is tied to ground, thus the analog switch 330 is always enabled in the schematic of FIG. 3. In some examples, the comparator 320 can be an analog comparator provided by Analog Devices, model number ADCMP601, and the analog switch 330 can be a switch provided by Nexperia, model number 74LVC2G53. When the analog switch receives a logic 0, the Y0 input is selected and thus, the input signal 310 passes through the analog switch 330 and is provided at the output Z. Conversely, when the selection signal S is at logic 1, then the Y1 input is selected, and the reference voltage VMID 333 will be provided at the output Z.

The output of the analog switch 330 is electrically coupled to a non-inverting input of the operational amplifier 340. As shown, the operational amplifier 340 is configured in an inverting amplifier configuration by the first resistor 350 provided between the output of the operational amplifier and the inverting input of the operational amplifier. The inverting input of the operational amplifier 340 is coupled to the input signal 310 via a second resistor R₂ 355. Thus, when the input signal 310 is positive, the amplifier 340 will follow the input signal in a non-inverting mode of operation, and when the input signal is below the reference signal reference voltage VMID, then the output 390 of the amplifier 340 will follow the input signal 310 in an inverting mode of operation. The operational amplifier 340 can be provided by any suitable operational amplifier circuit. In the illustrated example, operational amplifiers provided by Linear Technology, such as model numbers LTC6247 or LTC6246, can be used to provide the operational amplifier 340. Further, in the illustrated example, the first resistor 350 and the second resistor 355 are selected to have the same resistance value (R₁=R₂) of 4.7 kΩ.

In the example of FIG. 3, additional components have been introduced, in order to provide improved circuit performance when the input signal 310 switches with high frequency. For example, a feedback capacitor 360 is provided between the output of the operational amplifier 340 and its inverting input in order to help stabilize operation of the amplifier at a high frequency operation. Further, a 330 kΩ resistor 328 is provided at the hysteresis input of the comparator 320 to avoid toggling the comparator multiple times due to input noise as the input signal 310 crosses the VMID threshold. As will be readily understood by one of ordinary skill in the art having the benefit of the present disclosure, hysteresis can be provided using other types of circuits, for example, by using a Schmitt trigger, by configuring the comparator 320 for latched operation, or by providing another suitable circuit. As another optimization of the circuit, a Pi Network 370 is provided including two capacitors coupled to ground and having an intermediate resistor between the other terminals of the two capacitors. The Pi network 370 dampens high speed transients that may be generated by the analog switch 330 in order to prevent these transients from affecting operation of the operational amplifier 340. In some examples, only a resistor but not capacitors are provided between the analog switch 330 input Z and the input of the amplifier 340.

In some examples of the disclosed technology, the operation of the illustrated circuit can be adapted to perform different functionalities. For example, the circuit can be configured so that the input signal 310 is followed when its voltage is below the VMID reference node voltage, producing an inverted rectified signal (e.g., a signal that is substantially the negative absolute value of the input signal 310). The apparatus can be so configured by swapping the inputs of the comparator 320, swapping the inputs to the analog switch 330, or inverting the comparison output signal provided to the analog selector. In some examples, producing an inverted rectified signal is desirable when a following stage that receives the output is an inverting stage.

### V. Example Analog Switch Circuit

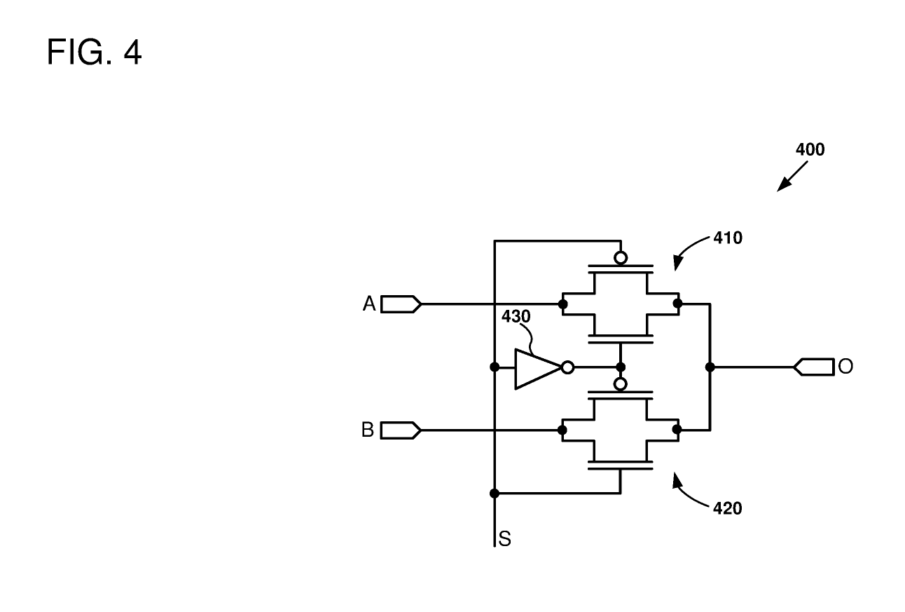

FIG. 4 is a schematic 400 depicting an example of a six-transistor circuit that can be used to implement an analog switch according to the disclosed technology. As shown, a first input A of the analog switch is provided to a two-transistor transmission gate 410 including an NMOS FET and a PMOS FET. A second input B is provided to the source terminals of another two-transistor transmission gate 420 including an NMOS FET and a PMOS FET. A selection signal S is configured using an inverter 430 to select either the first transmission gate 410 or the second transmission gate 420. The outputs of these transmission gates are coupled to an output. Thus, the illustrated circuit can be designed for high frequency operation due to the short propagation delay through the transmission gates, as well as the fast switching operation as the input signal crosses the reference voltage threshold, and therefore allows even relatively fast input signals to be rectified at the output of disclosed circuits.

### VI. Example Waveforms Generating Using Disclosed Circuits

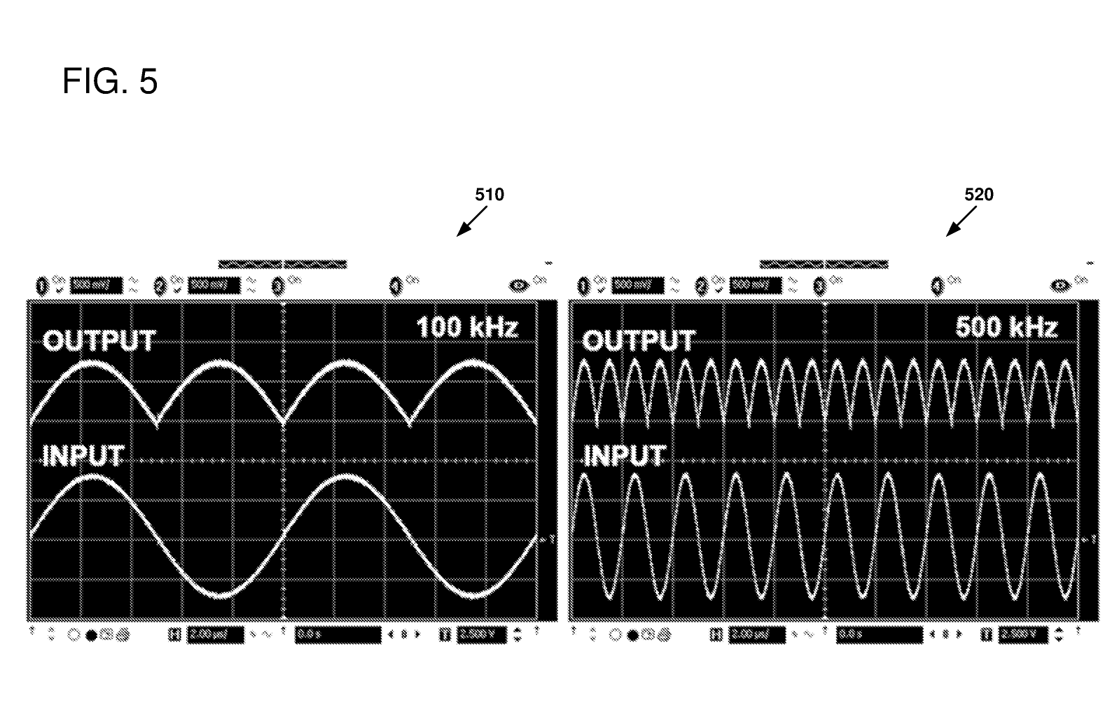

FIG. 5 includes two screen shots 510 and 520 generated by an oscilloscope measuring input and output signals of a circuit configured according to the example of FIG. 3. As shown in the first screen shot 510, an input signal is provided as a sine wave at 100 kHz frequency. The output of the circuit is also probed as shown, which provides a substantially full-wave rectified version of the input signal. The screen shot on the right, 520, shows input and output wave forms measured with an oscilloscope where the input wave form is a sine wave at an input frequency of 500 kHz. As shown, the circuit of FIG. 3 is able to produce a substantially full-wave rectified version of the input signal.

### VII. Additional Example Circuit Topology

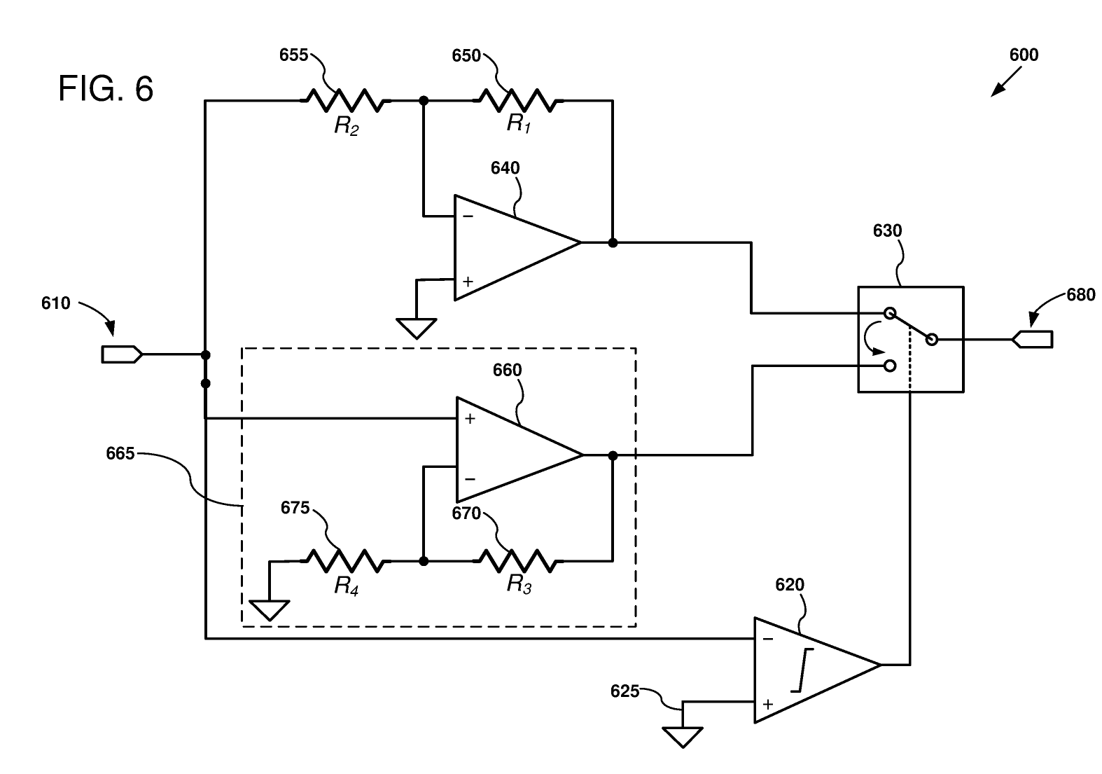

FIG. 6 is a schematic 600 illustrating an example of a mixed-signal topology that can be used for full-wave rectification in certain examples of the disclosed technology. For example, similar components such as those discussed above regarding FIGS. 1, 2, and/or 3 can be used to implement the illustrated circuit.

As shown, the circuit of FIG. 6 includes an input that receives an input signal 610 that is provided to the inverting input of a comparator 620. The non-inverting input of the comparator 620 is coupled to ground 625. Similar to the comparator discussed above regarding FIG. 2, when the input signal 610 is negative, the comparator 620 outputs a logic 1 and when the input signal 610 is positive relative to ground, then the comparator 620 outputs a logic 0. The output of the comparator 620 is coupled to a control input of an analog switch 630.

The illustrated analog switch 630 has two inputs, the first of which is coupled to a first amplifier 640, and the second of which is configured to follow the input signal 610 (e.g., by direct coupling or by coupling the second input to the output of a second amplifier 660). The first amplifier 640 is configured for inverting operation. The output of the amplifier 640 is coupled to a first resistor 650 having a resistance value R₁ which is fed back and coupled to the inverting input of the amplifier. A second resistor 655 has a resistance value R₂ and is coupled to the inverting input of the amplifier 640 and the other terminal of the resistor is coupled to the input signal 610. The non-inverting input of the first amplifier 640 is connected to ground. Thus, the output of the first amplifier will invert the input signal 610. In some examples, the first resistor 650 and the second resistor 655 will have the same value so that the gain of the first amplifier 640 is 1.

In some examples, the input signal 610 is coupled directly to the analog switch 630 and the optional configuration 665 including the second amplifier 660 is omitted from the circuit. The analog switch 630 thus will select the output of the inverting amplifier 640 when the input signal 610 is negative, and conversely will select the input signal 610 when the input signal has a voltage greater than ground. Thus, the signal observed at the output 680 of the circuit of FIG. 6 will provide a full-wave rectified output.

In some examples, the optional configuration 665 is employed to provide the second amplifier 660 operating as a non-inverting amplifier that follows the input signal 610. The output of the second amplifier 660 is directly coupled to the inverting input of the second amplifier 660 in order to provide feedback and to set the gain to +1. Thus, the output of the second amplifier 660 will follow the input signal 610 in a non-inverting fashion with a gain of +1. The analog switch 630 thus will select the output of the inverting amplifier 640 when the input signal 610 is negative, and conversely will select the output of the second non-inverting amplifier 660 when the input signal 610 has a voltage greater than ground. Thus, the signal observed at the output 680 of the circuit of FIG. 6 will provide a full-wave rectified output.

In other examples, the optional configuration 665 is employed to provide the second amplifier 660 configured to operate as a non-inverting amplifier that follows the input signal 610 with additional components. A third resistor 670 has a resistance value R₃ and a first terminal coupled to the output of the non-inverting amplifier 660, and its other terminal is coupled to the inverting input of the second amplifier 660. A fourth resistor 675 has a resistance value R₄ and has a first terminal coupled to the inverting input of the second amplifier 660, and its other terminal of the resistor is coupled to ground. Thus, the output of the second amplifier will follow the input signal 610 in substantially a non-inverting fashion. In some examples, the resistance values of the first and second resistors 650 and 655 are substantially the same, and the resistance values of the third and fourth resistors 670 and 675 are substantially the same. By providing the two resistors to each amplifier having substantially the same resistance value, the respective amplifier will have a gain of about 1. In some examples, all four of the illustrated resistors have substantially the same resistance value (R₁=R₂=R₃=R₄).

The analog switch 630 thus will select the output of the inverting amplifier 640 when the input signal 610 is negative, and conversely will select the output of the second non-inverting amplifier 660 when the input signal 610 has a voltage greater than ground. Thus, the signal observed at the output 680 of the circuit of FIG. 6 will provide a full-wave rectified output.

In some examples of the disclosed technology, the operation of the illustrated mixed-signal topology can be adapted to perform different functionalities. For example, the topology can be configured so that the input signal 610 is followed when its voltage is below the ground 625 voltage, producing an inverted rectified signal (e.g., a signal that is substantially the negative absolute value of the input signal 610). The apparatus can be so configured by swapping the inputs of the comparator 620, swapping the inputs to the analog switch 630, or inverting the comparison output signal provided to the analog selector. In some examples, producing an inverted rectified signal is desirable when a following stage that receives the output is an inverting stage.

### VIII. Example Method of Full-Wave Rectification

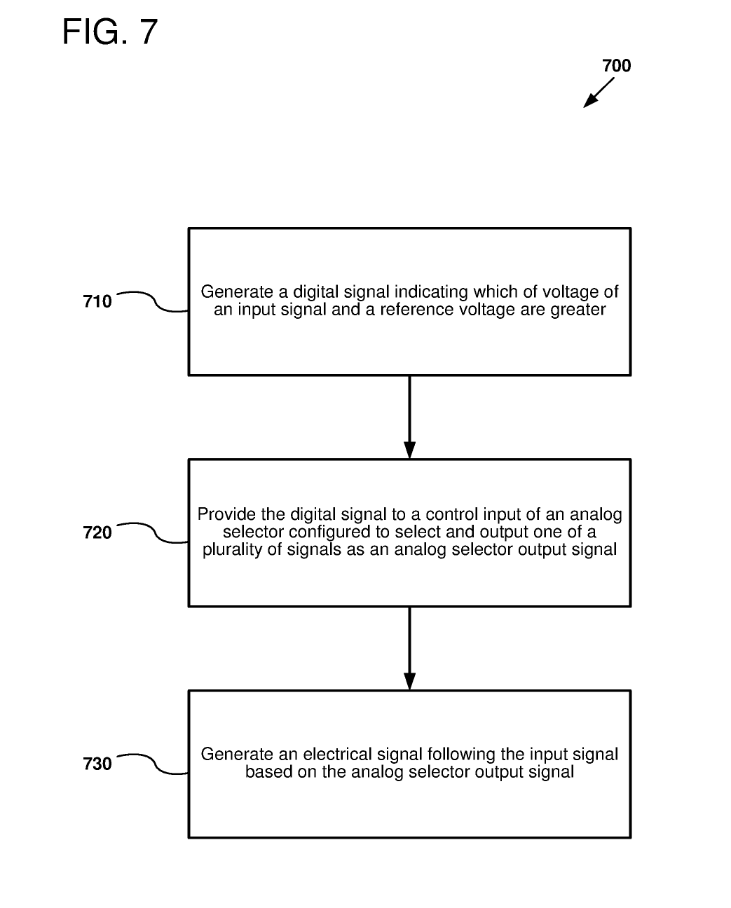

FIG. 7 is a flowchart 700 outlining an example method of generating a signal, for example, a full-wave rectified version of an input signal, as can be performed in certain examples of the disclosed technology. For example, the apparatus described above regarding any of FIG. 1, 2, 3, or 6 can be used to perform the illustrated method.

At process block 710, a digital signal is generated indicating which of the voltage of an input signal and the voltage of a reference voltage are greater. For example, the voltage of an input signal is compared to the voltage of a reference signal using a comparator or Schmitt trigger to generate a digital signal that indicates which of the input signal voltage and the reference signal voltage are greater. In some examples, the digital signal so generated can indicate which voltage is greater by providing a digital logic 1 or a digital logic 0 value, for example, at the full-rail values of the power supply of a comparator, Schmitt trigger, or other suitable circuit, as described in more detail above.

At process block 720, the digital signal generated at process block 710 is provided to a control input of an analog selector. The analog selector is configured to select an output based on the available inputs to the analog selector. In some examples the inputs and/or outputs of the analog selector are coupled to other circuitry such that the gain of the signal path will be positive when using one output and negative when using the other output. In this way, the digital signal output from process block 710 can be used to invert the gain in the signal path.

For example, the analog selector in process block 720 can be configured to output the input signal when the provided digital signal indicates that the input signal voltage is greater than the reference voltage. The analog selector is further configured to select an output of another reference voltage when the input signal voltage is not greater than the reference voltage. For example, the analog selector can be coupled to ground or to a reference voltage selected between the power and ground supply used in an implemented a circuit for performing the illustrated method.

At process block 730, an electrical signal is generated following the input signal (e.g., in an inverting or non-inverting rectifying manner) based on the analog selector output signal generated at process block 720. For example, an amplifier can be coupled to receive an analog selector output from the analog selector in order to change the sign of the gain of the signal path. In some examples, the gain of the amplifier is +1 when the output of the analog selector is the input signal and the gain of the amplifier is 1 when the output of the analog selector is a reference voltage.

In some examples of the outlined method, the input signal is provided at a frequency in a range from 100 kHz to 500 kHz. In some examples, the method further includes providing a sensor to generate the input signal. For example, any suitable transducer can be used to provide a signal as an input signal that is then rectified and provided as the output using the illustrated method. In some examples, the method further includes configuring one or more integrated circuits to perform the recited acts of the method.

In some examples of the disclosed technology, the example method acts can be adapted to perform different functionalities. For example, the method outlined in FIG. 7 can be used to produce an inverted rectified signal (e.g., a signal that is substantially the negative absolute value of the input signal). An inverted rectified signal can be produced by swapping the inputs to a comparison circuit used to generate the digital signal at process block 710, inverting the digital signal produced at process block 710, or by swapping the inputs of the analog selector used to select one of the plurality of signals at process block 720. In some examples, producing an inverted rectified signal is desirable when a following stage that receives the electrical signal generated at process block 730 is an inverting stage.

### IX. Example Method of Generating Amplified Signal Following an Input Signal

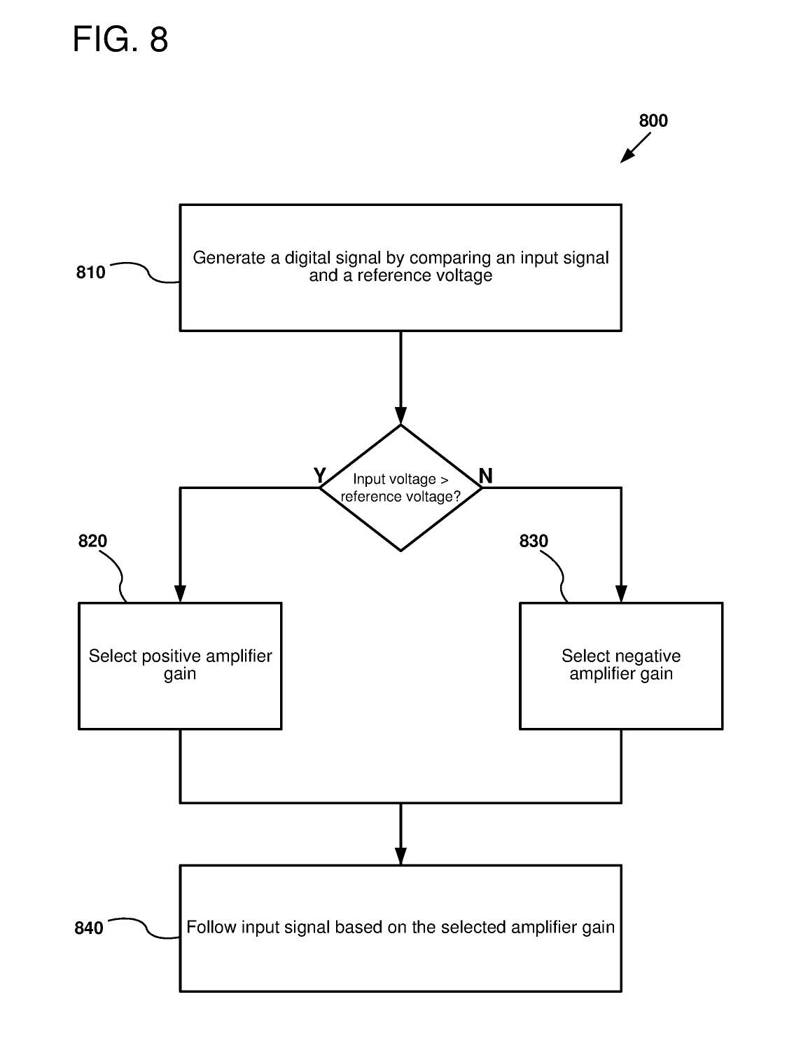

FIG. 8 is a flowchart 800 outlining an example method of generating an amplified signal that follows an input signal in an inverting or non-inverting fashion, as can be performed in certain examples of the disclosed technology. For example, the apparatus described above regarding any of FIG. 1, 2, 3, or 6 can be adapted to perform the illustrated method.

At process block 810, a digital signal is generated comparing an input signal and a reference signal. For example, voltage or current of an input signal can be compared to a reference signal (e.g., a static reference voltage at a selected voltage such as ground, a static voltage between ground and a positive or negative power voltage, or a dynamic reference voltage). For example, the voltage of an input signal is compared to the voltage of a reference signal using a comparator or a Schmitt trigger to generate a digital signal that indicates which of the input signal voltage and the reference signal voltage are greater. In some examples, the digital signal so generated can indicate which voltage is greater by providing a digital logic 1 or a digital logic 0 value, for example, at the full-rail values of the power supply of a comparator, Schmitt trigger, or other suitable circuit, as described in more detail above.

When the digital signal indicates that the input voltage is greater than the reference voltage, then the method proceeds to process block 820. When the digital signal indicates that the input voltage is less than the reference voltage, then the method proceeds to process block 830. In some examples, the digital signal is continuously generated at process block 810. In other examples, the digital signal is generated by comparing the signals at specific intervals.

At process block 820, a positive gain for the amplified output signal is selected. For example, an analog selector can be used to select the input signal, which is provided to an amplifier configured for non-inverting operation at process block 840.

At process block 830, a negative gain for the amplified output signal is selected. For example, an analog selector can be used to select a reference signal, causing an amplifier to operate in an inverting mode of operation. The analog selector can be used to select the reference voltage used at process block 810, or another reference voltage can be selected. In some examples, the reference signal is dynamic signal instead of a static, non-varying signal. The selected reference signal is provided to an amplifier at process block 840.

For example, the analog selector in process block 820 can be configured to output the input signal when the provided digital signal indicates that the input signal voltage is greater than the reference voltage. The analog selector is further configured to select an output of another reference voltage when the input signal voltage is not greater than the reference voltage. For example, the analog selector can be coupled to ground or to a reference voltage selected between the power and ground supply used in an implemented a circuit for performing the illustrated method.

At process block 840, the input signal is followed at a positive or negative gain, depending on the selection made at process block 820 or 830. In some examples, the signal is amplified with a gain of +1 or 1, respectively, depending on the selection made at process block 820 or 830. In some examples, the signal is amplified with a gain of greater than +1 or 1, or a gain less than +1 or 1, depending on the respective selection made at process block 820 or 830.

In some examples of the outlined method, the input signal is provided at a frequency in a range from 100 kHz to 500 kHz. In some examples, the method further includes providing a sensor to generate the input signal. For example, any suitable transducer can be used to provide a signal as an input signal that is then rectified and provided as the output using the illustrated method. In some examples, the method further includes configuring one or more integrated circuits to perform the recited acts of the method. In some examples, software or hardware can be used to configure whether the input or reference signal is selected. For example, a register can store a control bit that determines whether the method provides a non-inverted full-wave rectified output or an inverted full-wave rectified output by programming connections to a comparison circuit, an analog selector, and/or an amplifier.

In some examples of the disclosed technology, the example method acts can be adapted to perform different functionalities. For example, the method outlined in FIG. 8 can be used to produce an inverted signal (e.g., a signal that is substantially the negative absolute value of the input signal). An inverted signal can be produced by swapping the inputs to a comparator used to generate the digital signal at process block 810, inverting the digital signal produced at process block 810, by swapping the actions taken to select between process block 820 and process block 820, or by inverting the amplification at process block 840. In some examples, producing an inverted signal is desirable when a following stage that receives the electrical signal generated at process block 840 is an inverting stage.

### X. Additional Examples of the Disclosed Technology

Additional, non-limiting examples of the disclosed subject matter are discussed herein in accordance with the examples discussed above.

In some examples of the disclosed technology, an apparatus is configured to produce an output signal and includes a comparison circuit configured to generate a comparison output signal indicating whether an input signal voltage is greater than a reference signal voltage, an amplifier configured to generate an amplifier output signal following the input signal, and an analog selector configured to, based on the comparison output signal, select and output one of a plurality of signals as an analog selector output signal. The output is produced based on the analog selector output signal. In some examples, the comparison output signal is used to configure the apparatus to follow the input signal with a gain of +1 when the input signal is greater than a reference voltage, and to invert the input signal with a gain of −1 when the input signal is less than the reference voltage. In some examples, the comparison output signal is used to configure the apparatus to follow the input signal with a gain of −1 when the input signal is greater than a reference voltage, and to follow the input signal with a gain of +1 when the input signal is less than the reference voltage. In some examples, the reference voltage may be ground, another voltage in between ground and a power supply rail, or a varying signal. The comparison output signal can be used to configure the apparatus to operate in one of two or more modes of operation (e.g., following the input with a gain of +1 and inverting the input with a gain of −1).

In some examples of the apparatus, the amplifier is configured to be in a mode of operation determined by the analog selector output signal and the amplifier produces the output signal. In some examples, the mode of operation is an inverting amplifier mode or a non-inverting amplifier mode, the mode of operation being based on the analog selector output signal. In some examples, the amplifier provides at least one of the plurality of signals to the analog selector, and the analog selector produces the output signal. In some examples, the apparatus further includes a non-inverting amplifier that provides another one of the plurality of input signals to the analog selector.

In some examples, the apparatus is configured so that the output signal follows the input signal when the input signal voltage is greater than the reference signal voltage, and the output signal inversely follows the input signal when the input signal voltage is less than the reference signal voltage. In some examples, the apparatus is configured so that the output signal follows the input signal when the input signal voltage is less than the reference signal voltage, and the output signal inversely follows the input signal when the input signal voltage is greater than the reference signal voltage.

In some examples of the apparatus, the analog selector includes at least one of the following: an analog multiplexer, an analog switch, a transmission gate, or a pass gate. In some examples, the reference signal is a first reference signal and the plurality of input signals selectable by the analog selector consists of the input signal and a second reference signal. In some examples, the first reference signal is the same as the second reference signal. In some examples, the first reference signal is different than the second reference signal. In some examples, the first reference signal, the second reference signal, or the first reference signal and the second reference signal are non-varying voltages. In some examples, at least one of the first reference signal, the second reference signal, or the first reference signal and the second reference signal are time-varying voltages

In some examples, the comparison circuit includes at least one of the following circuits: a comparator with one or more digital outputs, an operational amplifier, a difference amplifier, an absolute value circuit, or a Schmitt trigger. In some examples, the comparison circuit generates the comparison output signal as a digital output level at about either a first power supply voltage or at about a second power supply voltage and the reference signal is a steady state voltage selected between the first power supply voltage and the second power supply voltage. In some examples, the amplitude of the input signal is provided substantially in a range from a ground voltage to a power voltage and the only power supply inputs to the comparison circuit and to the amplifier are a ground voltage and a power voltage.

In some examples of the disclosed technology, an apparatus includes a full-wave precision rectifier circuit having an input and an output, including a comparator having two comparator inputs and a comparator output indicating a difference in voltage between the two inputs, one of the inputs being coupled to the rectifier circuit input, an analog switch with a control input coupled to the comparator output, a first input coupled to an analog electrical input and a second input coupled to a reference input, the switch being configured to select one of an input signal or a reference signal to output as a switch output, and an amplifier coupled to receive the switch output and to generate an amplified signal following the rectifier circuit input at an output of the amplifier.

In some examples, the comparator can be replaced with an operational amplifier, a difference amplifier, an absolute value circuit, or a Schmitt trigger. In some examples, one of the comparator inputs is an inverting input, one of the comparator inputs is a non-inverting input, and the comparator is configured to generate a first full-rail output voltage at the output when voltage at the non-inverting input is greater than voltage at the inverting input, and to generate a second full-rail output voltage at the output when voltage at the non-inverting input is less than voltage at the inverting input. When the analog switch outputs the reference signal, the amplifier is configured to operate in an inverting amplifier configuration, and when the analog switch outputs the input signal, the amplifier is configured to operate in a non-inverting amplifier configuration. In other examples, when the analog switch outputs the reference signal, the amplifier is configured to operate in an non-inverting amplifier configuration, and when the analog switch outputs the input signal, the amplifier is configured to operate in an inverting amplifier configuration

In some examples, the amplifier further includes a feedback capacitor with a first terminal coupled to the amplifier output and with a second terminal coupled to the analog electrical input. In some examples, the switch output is provided to the amplifier via a Pi filter comprising a capacitor coupled to each terminal of a resistor, the resistor electrically coupling the switch output to a non-inverting input of the amplifier. In some examples, discrete capacitors are not provided as part of the Pi filter and only a resistor is used.

In some examples of the apparatus, the operation of the circuit can be modified to perform different functionalities. For example, the circuit can be configured so that the input signal is followed when its voltage is below the reference node voltage, producing an inverted rectified signal (e.g., a signal that is substantially the negative absolute value of the input signal. In some examples, the apparatus can be so configured by swapping the inputs of the comparator, swapping the inputs to the analog switch, or inverting the comparison output signal provided to the analog selector. In some examples, producing an inverted rectified signal is desirable when a following stage that receives the output is an inverting stage.

In some examples of the disclosed technology, an apparatus includes a full-wave precision rectifier circuit having an input and an output, including a comparator having two comparator inputs and a comparator output indicating a difference in voltage between the two inputs, one of the inputs being coupled to the rectifier circuit input, an analog switch with a control input coupled to the comparator output, a first input coupled to an analog electrical input and a second input coupled to a reference input, the switch being configured to select between two switch input signals as a switch output. In some examples, the input signal is coupled to the comparator inverting input and the non-inverting comparator input is coupled to ground. In some examples, the input signal is coupled to the comparator non-inverting input and the inverting comparator input is coupled to ground.

In some examples, one of the switch input signals is the input signal to the circuit and the other input signal is an inverted version of the input signal (e.g., produced by an amplifier with a gain of −1). In some examples, one of the input signals is an inverted version of the input signal and the other input signal is a non-inverted version of the amplified signal (e.g., produced by an amplifier having a gain of +1). In some examples, one or both amplifiers coupled to the switch inputs is configured to have a gain different than +/−1 using resistors in coupled to an operational amplifier feedback path.

In some examples, one of an input signal or a reference signal is output as a switch output, and an amplifier coupled to receive the switch output and to generate an amplified signal following the rectifier circuit input at an output of the amplifier.

In some examples, the circuit is implemented with discrete components mounted to a circuit board. In some examples, the circuit is implemented with components arranged on an integrated circuit substrate. In some examples, the circuit is implemented with individual components mounted in a multi-chip module package. In some examples, a sensor or other transducer coupled to the apparatus to provide the input signal.

In some examples of the disclosed technology a method of generating an electrical signal includes generating a digital signal indicating which of voltage of an input signal and a reference voltage are greater, providing the digital signal to a control input of an analog selector that is configured to select and output one of a plurality of signals as an analog selector output signal, and generating the electrical signal following the input signal based on the analog selector output signal. In some examples, the electrical signal follows the input signal with a gain of +1 when the input signal is greater than the reference voltage and follows the input signal with a gain of −1 when the input signal is less than the reference voltage. In some examples, the electrical signal follows the input signal with a non-unitary gain. Circuits used to implement the method can be configured to operate in inverting or non-inverting full wave rectifier operation by, for example, swapping inputs to a comparator, swapping inputs to an analog switch, inverting a control signal controlling the analog switch, or other suitable transformations. In some examples, configuration of the circuit is at least partially software or hardware controlled by providing a command that sets a value in a register or memory used to reconfigurably modify operation of the circuit (e.g., by swapping comparator or analog switch inputs).

In some examples of the method, the analog selector is further configured to select and output the input signal when the input signal voltage is greater than the reference voltage, the analog selector being further configured to select and output another reference voltage when the input signal voltage is not greater than the reference voltage. In some examples the method further includes providing an amplifier coupled to the analog selector output configured to produce an amplified output following the analog selector output in an inverting or non-inverting manner based on the selected analog selector output. In some examples, the method includes providing an amplifier configured to send an inverting output signal following the inputs signal to the analog selector that is further configured to select the inverting output signal or the input signal based on the digital signal. In some examples, a sensor or other transducer is provided to generate the input signal.

In view of the many possible embodiments to which the principles of the disclosed subject matter may be applied, it should be recognized that the illustrated embodiments are only preferred examples and should not be taken as limiting the scope of the claims to those preferred examples. Rather, the scope of the claimed subject matter is defined by the following claims. We therefore claim as our invention all that comes within the scope of these claims and their equivalents.

1. An apparatus configured to produce an output signal, the apparatus comprising:
a comparison circuit configured to generate a comparison output signal indicating whether an input signal voltage is greater than a reference signal voltage;
an amplifier configured to generate an amplifier output signal following the input signal the amplifier being configured to be in a mode of operation determined by an analog selector output signal; and
an analog selector configured to, based on the comparison output signal, select and output one of a plurality of signals as the analog selector output signal, wherein the output signal is produced based on the analog selector output signal, and wherein the output signal follows the input signal when the input signal voltage is greater than the reference signal voltage, and wherein the output signal inversely follows the input signal when the input signal voltage is less than the reference signal voltage.

2. (canceled)

3. The apparatus of claim 1, wherein the mode of operation is an inverting amplifier mode or a non-inverting amplifier mode, the mode of operation being based on the analog selector output signal.

4. The apparatus of claim 1, wherein:
the amplifier provides at least one of the plurality of signals to the analog selector; and
the analog selector produces the output signal.

5. The apparatus of claim 4, further comprising a non-inverting amplifier that provides another one of the plurality of input signals to the analog selector.

6. (canceled)

7. The apparatus of claim 1, wherein the analog selector comprises at least one of the following: an analog multiplexer, an analog switch, a transmission gate, or a pass gate.

8. The apparatus of claim 1, wherein:
the reference signal is a first reference signal; and
the plurality of input signals selectable by the analog selector consists of the input signal and a second reference signal.

9. The apparatus of claim 1, wherein the comparison circuit comprises at least one of the following circuits: a comparator with one or more digital outputs, an operational amplifier, a difference amplifier, an absolute value circuit, or a Schmitt trigger.

10. The apparatus of claim 1, wherein:
the comparison circuit generates the comparison output signal as a digital output level at about either a first power supply voltage or at about a second power supply voltage; and
the reference signal is a steady state voltage selected between the first power supply voltage and the second power supply voltage.

11. The apparatus of claim 1, wherein:
the only power supply inputs to the comparison circuit and to the amplifier are a ground voltage and a power voltage.

12. An apparatus comprising a full-wave precision rectifier circuit having an input and an output, the circuit comprising:
a comparator having two comparator inputs and a comparator output indicating a difference in voltage between the two inputs, one of the inputs being coupled to the rectifier circuit input;
an analog switch with a control input coupled to the comparator output, a first input coupled to an analog electrical input and a second input coupled to a reference input, the switch configured to select one of an input signal or a reference signal to output as a switch output; and
an amplifier coupled to receive the switch output and to generate a signal following the rectifier circuit input at an output of the amplifier.

13. The apparatus of claim 12, wherein:
one of the comparator inputs is an inverting input;
one of the comparator inputs is a non-inverting input; and
the comparator is configured to generate a first full-rail output voltage at the output when voltage at the non-inverting input is greater than voltage at the inverting input, and to generate a second full-rail output voltage at the output when voltage at the non-inverting input is less than voltage at the inverting input.

14. The apparatus of claim 12, wherein:
when the analog switch outputs the reference signal, the amplifier is configured to operate in an inverting amplifier configuration; and
when the analog switch outputs the input signal, the amplifier is configured to operate in a non-inverting amplifier configuration.

15. The apparatus of claim 12, wherein the amplifier further comprises a feedback capacitor with a first terminal coupled to the amplifier output.

16. The apparatus of claim 12, wherein the switch output is provided to the amplifier via a filter comprising a capacitor coupled to each terminal of a resistor, the resistor electrically coupling the switch output to a non-inverting input of the amplifier.

17. A method comprising:
generating a digital signal indicating which of voltage of an input signal and a reference voltage are greater;
providing the digital signal to a control input of an analog selector, the analog selector being configured to select and output one of a plurality of signals as an analog selector output signal; and
providing an amplifier coupled to the analog selector output, the amplifier being configured to generate an electrical signal following the input signal in an inverting or non-inverting manner based on the selected analog selector output.

18. The method of claim 17, wherein:
the analog selector is further configured to select and output the input signal when the input signal voltage is greater than the reference voltage, the analog selector being further configured to select and output another reference voltage when the input signal voltage is not greater than the reference voltage.

19. The method of claim 17, further comprising:
providing an amplifier configured to send an inverting output signal following the inputs signal to the analog selector; and
wherein the analog selector is further configured to select the inverting output signal or the input signal based on the digital signal.

20. The method of claim 17, further comprising providing a sensor to generate the input signal.
